(19) United States
(12) Patent Application Publication
(10) Pub. No.: US 2009/0169748 A1
(43) Pub. Date: Jul. 2, 2009

(54) INKS FOR HIGH SPEED DURABLE INKJET PRINTING

(76) Inventors: Gary L. House, Victor, NY (US); Thomas B. Brust, Webster, NY (US); Yongcai Wang, Webster, NY (US)

Correspondence Address: EASTMAN KODAK COMPANY;PATENT LEGAL STAFF, 343 STATE STREET, ROCHESTER, NY, 14650-2201, US

(21) Appl. No.: 12/234,744

(22) Filed: Sep. 22, 2008

Related U.S. Application Data
(60) Provisional application No. 61/017,013, filed on Dec. 27, 2007.

(51) Int. Cl. B05D 1/02; C09D 175/04

(52) U.S. Cl. 427/256; 524/507

(57) ABSTRACT

An ink composition comprising: (a) water; (b) a pigment dispersion comprising a pigment and a polymeric dispersant wherein the polymeric dispersant is a copolymer comprising at least a hydrophobic methacrylate or acrylate monomer containing an aliphatic chain having greater than or equal to 12 carbons, and a hydrophilic methacrylic or acrylic acid monomer, wherein the copolymer comprises at least 10% by weight of the methacrylate or acrylate monomer and at least 5% by weight of the methacrylic or acrylic acid monomer, and wherein the copolymer comprises, in total, 20 to 95 weight % of hydrophobic monomer; and (c) at least one water-dispersible polyurethane.

### CROSS-REFERENCE TO RELATED APPLICATIONS

This is a 111A application of Provisional Application Ser. No. 61/017,013, filed Dec. 27, 2007.

### FIELD OF THE INVENTION

The invention relates generally to the field of pigmented inks for inkjet printing, and in particular to inks which are useful for thermal inkjet printing. More specifically, the invention relates to pigmented inks for high-speed thermal inkjet printing which exhibit excellent stability and which result in high quality images when printed to an inkjet receiver.

### BACKGROUND OF THE INVENTION

Inkjet printing is a non-impact method for producing printed images by the deposition of ink droplets in a pixel-by-pixel manner to an image-recording element in response to digital signals. There are various methods that may be utilized to control the deposition of ink droplets on the image-recording element to yield the desired printed image. In one process, known as drop-on-demand inkjet, individual droplets are projected as needed onto the image-recording element to form the desired printed image. Common methods of controlling the ejection of ink droplets in drop-on-demand printing include thermal bubble formation (thermal inkjet (TIJ)) and piezoelectric transducers. In another process known as continuous inkjet (CIJ), a continuous stream of droplets is generated and expelled in an image-wise manner onto the surface of the image-recording element, while non-imaged droplets are deflected, caught, and recycled to an ink sump. Inkjet printers have found broad applications across markets ranging from desktop document and photographic-quality imaging, to short run printing and industrial labeling.

Ink compositions containing colorants used in inkjet printers can be classified as either pigment-based, in which the colorant exists as pigment particles suspended in the ink composition, or as dye-based, in which the colorant exists as a fully solvated dye species that consists of one or more dye molecules. Pigments are highly desirable since they are far more resistant to fading than dyes. However, pigment-based inks have a number of drawbacks. Great lengths must be undertaken to reduce a pigment to a sufficiently small particle size and to provide sufficient colloidal stability to the particles. Pigment-based inks often require a lengthy milling operation to produce particles in the sub-micron range needed for most modern ink applications. If the pigment particles are too large, light scattering can have a detrimental effect on optical density and gloss in the printed image.

A second drawback of pigmented inks is their durability after printing, especially under conditions where abrasive forces have been applied to the printed image. Furthermore, the images printed onto an inkjet receiver are susceptible to defects at short time intervals, from immediately after printing to several minutes while the inks are drying. Finally, the durability of the dried image is also subject to environmental factors such as temperature and humidity which, under certain circumstances, can degrade image durability.

To this extent, pigmented inks have been formulated with various polymers, dispersants and other addenda in attempts to provide durable images that can withstand post printing physical abuse and environmental conditions. Pigmented inks for inkjet printing have been formulated with acrylic polymers; however, acrylic polymers alone may be insufficient in providing durable images that resist scratches and other forms of physical abuse.

A second class of polymers that have been used as abrasion resistance additives in pigment-based inks are the polyurethanes, or urethane resins as they are sometimes called. U.S. Pat. No. 6,136,890 discloses a pigment-based inkjet ink wherein the pigment particles are stabilized by a polyurethane dispersant. US Publication No. 2004/0242726 discloses a pigment dispersed by a cross-linking step between a resin having a urethane bond and a second water-soluble polymer. US Publication No. 2004/0229976 discloses polyurethane/polyurea resins for pigmented inks where the weight fraction of a polyurethane urea part is at most 2.0 wt % to the urethane resin.

Although polyurethanes are known for their excellent abrasion resistance, they also have a number of drawbacks. For example, not all polyurethane polymers are conducive to jetting from a thermal inkjet head. In particular, water-dispersible polyurethane particles, such as those disclosed in U.S. Pat. Nos. 6,533,408; 6,268,101; Statutory Invention Registration No. US H21131H, and US Publication Numbers 2004/0130608 and 2004/0229976 are particularly difficult to jet from a thermal inkjet printhead at high firing frequencies. The molecular weight of the polyurethane binder plays an important role in the ink performance and durability of the resulting printed images. For example, molecular weights below about 8,000 generally do not provide highly durable images. On the other hand, molecular weights above about 50,000, and especially above 150,000, can raise the viscosity of the ink, which may be detrimental to firing performance from a thermal inkjet printhead.

It is also known in the art of pigment-based inkjet inks to combine a polyurethane with a second polymer, such as an acrylic polymer or polyester. U.S. Pat. No. 6,794,425 discloses a mixture of a hydrophilic polyurethane and a hydrophobic polymer where the molecular weights of polymers are specified. US Publication No. 2003/0166742 discloses the combination of a polyurethane and a second copolymer where the acid numbers of the polymers are specified. The acid number of the polyurethane also creates limitations for use in an inkjet printing system. If the acid number of the polyurethane is too high the resulting abrasion resistance of the image can become degraded, especially under conditions of high temperature and high humidity. If the acid number of the polyurethane is too low a substantial amount of particulate polymer will exist and jetting can become degraded.

Pigment based inks can be difficult to jet through inkjet printheads having small nozzle diameters especially by the thermal inkjet printing process. In recent years, thermal inkjet printers have moved to higher jetting frequencies to provide faster printing speeds. Thermal inkjet printers are now capable of printing at jetting frequencies in excess of 10 kHz and the ability for higher velocity firings is a highly desirable feature. However, this high frequency firing often comes at the cost of variability in the drop velocity, which leads to poor image quality in the final printed image. In addition, the demands of current thermal inkjet printing require that the nozzles fire for a large number of firings during the lifetime of a printer. As an example, a typical inkjet nozzle may be required to fire in excess of 5×10⁷, and up to as many as 1×10⁹, individual firing events without malfunctioning or ceasing to fire altogether.

### PROBLEM TO BE SOLVED BY THE INVENTION

Although the use of polyurethane and acrylic binders have found use in inkjet printers, there remains the need to provide pigment-based inks that are, simultaneously, stable to particle growth, capable of providing durable images with high maximum densities, and which satisfy the demands of high frequency thermal inkjet printing. It is therefore an object of this invention to provide a pigment-based ink, and an ink set including two or more pigment-based inks for inkjet printing whereby each of the pigment-based inks contain a polyurethane binder which jet from a thermal inkjet printhead at high frequency and with low variability. It is a further objective of the present invention that the pigment-based ink compositions containing the polyurethane binder provide excellent image quality, which enable high maximum densities, and maintain durability when printed to an inkjet receiver.

### SUMMARY OF THE INVENTION

In accordance with one embodiment, the invention is directed towards an inkjet ink composition comprising:

(a) water,

(b) a pigment dispersion comprising a pigment and a polymeric dispersant wherein said polymeric dispersant is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer, and

(c) at least one water-dispersible polyurethane.

### DETAILED DESCRIPTION OF THE INVENTION

The inkjet inks of the present invention are aqueous-based inks. Aqueous-based is defined herein as ink comprising mainly water as the carrier medium for the remaining ink components. In a preferred embodiment, the inks of the present invention comprise at least about 50 weight percent water. Pigment-based inks are defined as inks containing at least a dispersion of water-insoluble pigment particles. Dye-based inks are defined as inks containing at least a colored dye, which is soluble in the aqueous carrier. Colorless inks are defined as inks which are substantially free of colorants such as dyes or pigments and as such are not intended to contribute to color formation in the image forming process.

An ink set is defined as a set of two or more inks. The ink sets may contain pigment-based inks of different colors, for example, cyan, magenta, yellow, red, green, blue, orange, violet, or black. In one embodiment, a carbon black pigmented ink is used in an ink set comprising at least three inks having separately, a cyan, a magenta, and a yellow colorant. Useful ink sets also include, in addition to the cyan, magenta, and yellow inks, complimentary colorants such as red, blue, violet, orange, or green inks. In addition, the ink set may comprise light and dark colored inks, for example, light cyan and light magenta inks commonly used in the ink sets of wide format printers. It is possible to include one or more inks that comprise a mixture of different colored pigments in the ink set. An example of this is a carbon black pigment mixed with one or more colored pigments or a combination of different colored pigments. An ink set may also include one or more pigment-based inks in combination with one or more colorless inks. An ink set may also include at least one or more pigment-based inks in combination with additional inks that are dye-based inks.

The pigment-based inks of the present invention comprise pigment particles dispersed in the aqueous carrier. The pigment particles that are useful in the invention may be prepared by any method known in the art of inkjet printing. Useful methods commonly involve two steps: (a) a dispersing or milling step to break up the pigments to primary particles, where primary particle is defined as the smallest identifiable subdivision in a particulate system; and (b) a dilution step in which the pigment dispersion from step (a) is diluted with the remaining ink components to give a working strength ink.

The milling step (a) is carried out using any type of grinding mill such as a media mill, ball mill, two-roll mill, three-roll mill, bead mill, and air-jet mill; an attritor; or a liquid interaction chamber. In the milling step (a), pigments are optionally suspended in a medium that is typically the same as or similar to the medium used to dilute the pigment dispersion in step (b). Inert milling media are optionally present in the milling step (a) in order to facilitate break up of the pigments to primary particles. Inert milling media include such materials as polymeric beads, glasses, ceramics, metals, and plastics as described, for example, in U.S. Pat. No. 5,891,231. Milling media are removed from either the pigment dispersion obtained in step (a) or from the ink composition obtained in step (b).

A dispersant is present in the milling step (a) in order to facilitate break up of the pigments into primary particles. For the pigment dispersion obtained in step (a) or the ink composition obtained in step (b), a dispersant is present in order to maintain particle stability and prevent settling. Polymeric dispersants are known and useful in aqueous pigment-based ink compositions. Polymeric dispersants may be added to the pigment dispersion prior to, or during the milling step. Typically, these polymeric dispersants are copolymers made from hydrophobic and hydrophilic monomers.

In this case, the copolymers are designed to act as dispersants for the pigment by virtue of the arrangement and proportions of hydrophobic and hydrophilic monomers. The pigment particles are colloidally stabilized by the dispersant and are referred to as a polymer dispersed pigment dispersion. The pigment dispersions useful in pigment-based ink compositions desirably have a median particle diameter of less than 200 nm and more preferably less than 100 nm.

The inkjet ink composition of the invention is comprised of a pigment dispersion consisting of pigment particles in association with a polymeric dispersant. The polymeric dispersants useful in the present invention are copolymers prepared from at least one hydrophilic monomer that is an acrylic acid or methacrylic acid monomer, or combinations thereof. Preferably, the hydrophilic monomer is methacrylic acid. The hydrophilic monomer is present in the copolymer in an amount of at least 5% based on the total weight of the copolymer, and more preferably at least 15% of the total weight, and most preferably at least 20% by weight of the total weight.

The polymeric dispersants of the invention also comprise at least one hydrophobic monomer. The hydrophobic monomer used to prepare the polymeric dispersant of the present invention is comprised of a carboxylic acid ester-containing functional group. The hydrophobic monomers may be selected from any aliphatic acrylate or methacrylate monomer provided it contains an aliphatic chain comprising greater than or equal to 12 carbon atoms. The chains comprising greater than or equal to 12 carbons may be linear or branched. Examples of specific hydrophobic monomers useful in the present invention include the following: lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, decyltetradecyl methacrylate, and the like. Preferably the methacrylate or acrylate monomer is stearyl or lauryl methacrylate or acrylate. The hydrophobic portion of the polymer may be prepared from one or more of the hydrophobic monomers.

The hydrophobic monomer having a carbon chain length of greater than or equal to 12 carbons is present in an amount of at least 10% by weight of the total copolymer, and more preferably greater than 20% by weight. Polymeric dispersants having at least 30% of the long chain hydrophobic monomer are particularly good for stabilizing the pigment particles in aqueous ink compositions against particle growth. The copolymer may also comprise, in addition to the hydrophobic monomer comprising greater than or equal to 12 carbon chains, a hydrophobic monomer comprising an aromatic group. For example, the additional aromatic group containing monomer may be styrene, benzyl acrylate, or benzyl methacrylate. A preferred additional monomer is benzyl methacrylate.

The total amount of hydrophobic monomers, comprising the monomer having a chain with greater than or equal to 12 carbons and optionally, monomer containing an aromatic group, are present in the polymer in an amount of 20 to 95% by weight of the total polymer. The hydrophobic aromatic-group containing monomer may be present in an amount from about 0 to 85% by weight of the total polymer, more preferably from about 0 to 60%, and most preferably from about 0 to 50%. Examples of such polymers are described in US Publication Number 2007/0043144, which is incorporated by reference herein in its entirety.

The polymeric dispersant (copolymer) employed in the present invention is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC triblock wherein, at least one of the A, B, and C blocks is chosen to be the hydrophilic monomer and the remaining blocks are hydrophobic blocks dissimilar from one another. Preferably the copolymer is a random copolymer.

The weight average molecular weight of the polymeric dispersant employed in the present invention has an upper limit such that it is less than about 50,000 daltons. Desirably, the weight average molecular weight of the copolymer is less than about 25,000 daltons; more preferably it is less than 15,000 and most preferably less than 10,000 daltons. The molecular weight of the copolymer of the present invention has a weight average molecular weight lower limit such that it is greater than about 500 daltons.

Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

The pigment particles of the present invention are dispersed by the polymeric dispersant in an amount sufficient to provide stability in the aqueous suspension and subsequent ink. The amount of dispersant relative to pigment is a function of the desired particle size and related surface area of the fine particle dispersion. The weight ratio of pigment to polymeric dispersant can range from about 10:1 to about 1:1, and more preferably from about 5:1 to about 2:1. It is understood that the amount of polymer and relative ratios of the monomer constituents can be varied to achieve the desired particle stability and ink firing performance for a given pigment, as it is known that pigments can vary in composition and affinity for the polymeric dispersant.

The inks of the invention may also optionally comprise self-dispersing pigments that are dispersible without the use of a dispersant. Pigments of this type are those that have been subjected to a surface treatment such as oxidation/reduction, acid/base treatment, or functionalization through coupling chemistry. The surface treatment can render the surface of the pigment with anionic, cationic or non-ionic groups. Examples of self-dispersing type pigments include, but are not limited to, Cab-O-Jet® 200 and Cab-O-Jet® 300 (Cabot Corp.) and BONJET® Black CW-1, CW-2, and CW-3 (Orient Chemical Industries, Ltd.).

The pigments used in the ink composition of the invention may be present in any effective amount, generally from 0.1 to 10% by weight, and preferably from 0.5 to 6% by weight, more preferably from 1 to 4% by weight.

Ink compositions useful in the invention can also comprise a humectant in order to achieve high frequency firing with low variability. Representative examples of humectants which may be employed in the present invention include: (1) triols, such as; glycerol, 1,2,6-hexanetriol, 2-ethyl-2-hydroxymethyl-propane diol, trimethylolpropane, alkoxlated triols, alkoxylated pentaerythritols, saccharides and sugar alcohols; and (2) diols, such as ethylene glycol, diethylene glycol, triethylene glycol, propylene glycol, polyalkylene glycols having four or more alkylene oxide groups, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol; and (3) thioglycol, or a mixture thereof. Typical aqueous-based ink compositions useful in the invention may contain 2-25 weight percent humectant(s), more preferably from about 6-20% humectant, most preferably from about 8-15% humectant.

The ink compositions of the present may also include, in addition to the humectant, a water miscible co-solvent or penetrant. Representative examples of co-solvents used in the aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, and diethylene glycol monobutyl ether acetate; (3) nitrogen-containing compounds such as urea, 2-pyrrolidinone, N-methyl-2-pyrrolidinone, and 1,3-dimethyl-2-imidazolidinone; and (4) sulfur-containing compounds such as 2,2′-thiodiethanol, dimethyl sulfoxide and tetramethylene sulfone. Typical aqueous-based ink compositions useful in the invention may contain 2-10 weight percent co-solvent(s).

Particular humectant and co-solvents useful in the present invention are 1,2-alkane diols (e.g. 1,2-hexane diol and 1,2-pentane diol) and lower alkyl glycol ethers (e.g. polyethyleneglycol monobutyl ether and diethyleneglycol monomethyl ether). These compounds are advantageous since inks formulated with the inventive polymeric dispersed pigments can provide increased density and reduced mottle when printed onto plain papers. This is an advantage over surfactant dispersed pigments or other polymeric dispersed pigments known in the art since these systems can be destabilized by the high surface activity of the 1,2 alkane diols or alkyl glycol ethers.

Ink compositions of the present invention comprise at least one water-dispersible polyurethane compound. Water-dispersible is defined herein to include individual polymer molecules or colloidal assemblies of polymer molecules which are stably dispersed in the ink without the need for a dispersing agent. Water dispersible polyurethanes employed in the present invention may have the general formula of (I)

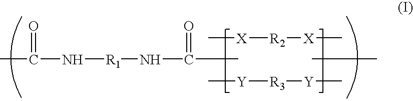

wherein R₁ in the structure (I) above is the central portion of the monomer unit that is the polymerization product of a diisocyanate; R₂ represents the central portion of a unit that is the polymerization product of at least one type of polyol or, optionally, a polyamine; R₃ is the central portion of a unit containing an acid group; and X and Y can be the same or different and are —O— or —N— atom.

R₁ is preferably a hydrocarbon group having a valence of two, more preferably containing a substituted or unsubstituted alicyclic, aliphatic, or aromatic group, preferably represented by one or more of the following structures:

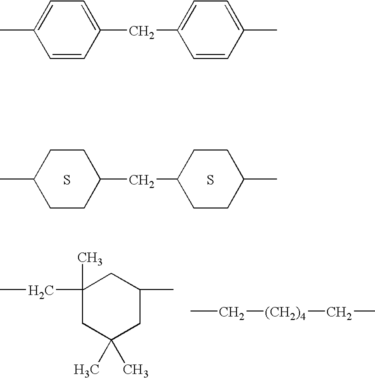

R₂ preferably represents a soft segment comprising a prepolymer having ester, carbonate, or ether linkages.

The soft segment is introduced into the polyurethane backbone by using the prepolymer with both ends terminated with a hydroxyl (diol) or an amino (diamine) group. The prepolymer having terminal hydroxyl groups is known as polyols, and that having terminal amine groups is known as polyamine. Polyols useful for the practice of the invention include a) a polyester polyol obtained by, for example, esterification of a dicarboxylic acid with a diol; or ring opening reaction of a lactone (e.g. Ö-caprolactone) and a diol; b) a polycarbonate polyol obtained, for example, by reacting a diols with diaryl carbonates or phosgene, and a polyether diol; and c) a polyether polyol as a condensation product of, for example, ethylene glycol, propylene glycol, or tetramethylene glycol. Preferably the polyols have a molecular weight above about 300 and below about 3000. Polyamines useful for the practice of the invention include those sold under the trade name JEFFAMINE® D, ED, and M series from HUNTSMAN. Another more preferred polyether diamine is a polytetrahydrofuran bis(3-aminopropyl) terminated having a molecular weight of about 1,000.

R₃ is preferably the central portion of a monomeric unit containing a phosphoric acid, carboxylic acid, or sulfonic acid group, most preferably being carboxylic acids, such as 2,2′-bis(hydroxymethyl)propionic acid, 2,2′-bis(hydroxymethyl)butoric acid, hydroxyethylether of 4,4′-bis(4-hydroxyphenyl)valeric acid. These materials may be prepared by any of the well known techniques in art of polyurethane manufacture, for example, processes disclosed in U.S. Pat. No. 4,335,029 Dadi, et al. assignee Witco Chemical Corporation (New York, N.Y.) and in “Aqueous Polyurethane Dispersions” by B. K. Kim, Colloid & Polymer Science, Vol. 274, No. 7 (1996) 599-611© Steinopff Verlag 1996.

Preferred polyurethanes of this invention have a sufficient amount of acid groups in the molecule to have an acid number from about 50 to about 150, more preferably from about 60 to about 140, and most preferably from about 65 to about 130, wherein, the acid number is defined as the milligrams of potassium hydroxide required to neutralize one gram of polymer. The acid number of the polymer may be calculated by the formula given in the following equation:

Acid number=(moles of acid monomer)*(56 grams/mole)*(1000)/(total grams of monomers)

where, moles of acid monomer is the total moles of all acid groups containing monomers that comprise the polymer, 56 is the formula weight for potassium hydroxide, and total grams of monomers is the summation of the weight of all the monomers, in grams, comprising the target polymer.

Polyurethane dispersions useful for the practice of the invention can be prepared by preparing a prepolymer having a relatively low molecular weight and a small excess of isocyanate groups and chain-extending with a chain extender the prepolymers into a high molecular weight polyurethane during the dispersion process. Such processes have been disclosed in, for example, US Pat. No. 4,335,029 by Dadi, et al. assigned to Witco Chemical Corporation (New York, N.Y.); in “Aqueous Polyurethane Dispersions” by B. K. Kim, Colloid & Polymer Science, Vol. 274, No. 7 (1996) 599-611 © Steinopff Verlag 1996; and in “Polyurethane Dispersion Process” by Mania et al. Paint and Coating Industry, January 2007, Page 30.

Preferred diamine chain extenders for the practice of the invention include ethylene diamine, diethylene triamine, propylene diamine, butylene diamine, hexamethylene diamine, cyclohexylene diamine, phenylene diamine, tolylene diamine, xylylene diamine, 3,3′-dinitrobenzidene, ethylene methylenebis(2-chloroaniline), 3,3′-dichloro-4,4′-biphenyl diamine. 2,6-diaminopyridine, 4,4′-diamino diphenylmethane, adducts of diethylene triamine with acrylate or its hydrolyzed products, hydrazine, and substituted hydrazines.

The polyurethane dispersions useful for the practice of this invention can also be prepared without involving the chain-extension step during the dispersion step. In the process the chemical reaction for forming urethane or urea linkages is completed prior to the dispersion step.

The polyurethane of this invention typically will have a minimum molecular weight of at least 8,000. Preferably, the polyurethane has a maximum molecular weight of 150,000. More preferably, the molecular weight of the polyurethane is between about 10,000 and 100,000, and most preferably between about 15,000 and 50,000. The polyurethane dispersions useful for the practice of this invention preferably have a mean particle size of less than 100 nm and more preferably less than 50 nm.

The acid groups on the polyurethanes and the acrylic polymer dispersants are at least partially neutralized (converted into salts) using organic or inorganic bases, preferably monovalent inorganic bases, and most preferably aqueous alkaline metal hydroxides, selected from potassium hydroxide, sodium hydroxide, rubidium hydroxide, or lithium hydroxide. In a preferred embodiment, at least 50 percent of the available acid groups on the polymer are converted into salts using monovalent inorganic base, more preferably at least 70%, and most preferably at least 85%, of the available acid groups are converted. From a manufacturing perspective, preferably less than 100% of the acid groups are neutralized as this can lead to lack of control of the pH of the inks. Monovalent inorganic bases are highly preferred over organic bases such as amines as the neutralizing agents for the acrylic and polyurethane polymers since inks containing polymers neutralized with organic amines show very poor jetting performance in a thermal inkjet printhead.

Inks formulated with the inventive combination of both pigment particles stabilized by the polymeric dispersants and water-dispersible polyurethanes provide advantageous plain paper density when compared to use of other polymeric dispersants of the prior art.

In another preferred embodiment, the components of the ink composition are selected such that the ink viscosity is less than about 4.0 centapoise at 25 degrees Celsius, more preferably less than about 3.0, even more preferably less than 2.5 and most preferably less than 2.0. Ink compositions defined by these preferred embodiments are capable of achieving high firing frequencies with low variability for a large number of firing events.

Surfactants may be added to adjust the surface tension of the ink to an appropriate level. In a particular embodiment, relative dynamic and static surface tensions of various pigment based inks and colorless protective ink of an ink set may be controlled as described in copending, commonly assigned U.S. patent application Ser. No. 12/029,986 filed Feb. 12, 2008, the disclosure of which is incorporated by reference herein, to control intercolor bleed between the inks. In particular, where cyan, magenta, yellow, black, and colorless inks are employed, the surface tensions of the inks may have the relationships wherein (i) the dynamic surface tension at 10 milliseconds surface age for all inks of the ink set is greater than or equal to 35 mN/m; (ii) the static surface tensions of the yellow ink and of the colorless protective ink are at least 2.0 mN/m lower than the static surface tensions of the cyan, magenta, and black inks of the ink set; and (ii) the static surface tension of the colorless protective ink is at least 1.0 mN/m lower than the static surface tension of the yellow ink.

The surfactants may be anionic, cationic, amphoteric or nonionic and used at levels of 0.01 to 5% of the ink composition. Examples of suitable nonionic surfactants include linear or secondary alcohol ethoxylates (such as the TERGITOL® 15-S and TERGITOL® TMN series available from Union Carbide and the BRIJ® series from Uniquema), ethoxylated alkyl phenols (such as the TRITON® series from Union Carbide), fluoro surfactants (such as the ZONYLS® from DuPont; and the FLUORADS® from 3M), fatty acid ethoxylates, fatty amide ethoxylates, ethoxylated and propoxylated block copolymers (such as the PLURONIC® and TETRONIC® series from BASF), ethoxylated and propoxylated silicone based surfactants (such as the SILWET® series from CK Witco), alkyl polyglycosides (such as the GLUCIOIBS® from Cognis), and acetylenic polyethylene oxide surfactants (such as the Surfynols from Air Products).

Examples of anionic surfactants include carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates, and alkyl naphthalene sulfonates), phosphated (such as phosphated esters of alkyl and aryl alcohols, including the STRODEX® series from Dexter Chemical), phosphonated and amine oxide surfactants, and anionic fluorinated surfactants. Examples of amphoteric surfactants include betaines, sultaines, and aminopropionates. Examples of cationic surfactants include quaternary ammonium compounds, cationic amine oxides, ethoxylated fatty amines, and imidazoline surfactants. Additional examples of the above surfactants are described in “McCutcheon's Emulsifiers and Detergents: 1995, North American Editor.”

A biocide (0.01-1.0% by weight) may also be added to prevent unwanted microbial growth which may occur in the ink over time. A preferred biocide for the inks employed in the present invention is PROXEL® GXL (Zeneca Colours Co.) at a concentration of 0.05-0.1% by weight or KORDEK® (Rohm and Haas Co.) at a concentration of 0.05-0.1% by weight (based on 100% active ingredient. Additional additives which may optionally be present in an inkjet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers, and defoamers.

The pH of the aqueous ink compositions of the invention may be adjusted by the addition of organic or inorganic acids or bases. Inorganic bases are preferred, however small amounts of organic bases, such as triethanolamine, may be used to adjust the pH of the ink. Useful inks may have a preferred pH of from about 4 to 10, depending upon the type of pigment being used. Preferably, the pH of the present ink is from 6 to 9, more preferably from 7.5 to 8.5.

The inks of the present invention can be printed through an inkjet printhead capable of achieving firing frequencies of at least 12 kHz with a near nozzle velocity of at least 10 meters/second. Any of the known printhead designs in the art of inkjet printing may be used which are capable of achieving these high speed firing frequencies. Preferably, the inkjet printer is equipped with a thermal inkjet printhead. Particularly preferred printhead designs are disclosed in U.S. Pat. No. 7,350,902 and commonly assigned, copending application US Publication No. 2008/0136867, the disclosures of which are incorporated by reference herein.

Inks of the present invention may be applied to a photoglossy or plain paper receiver. The two types of receivers are distinguished from one another in that the photoglossy receiver is manufactured with a coated layer above the underlying paper support. Examples of plain papers include: Kodak bright white inkjet paper, Hewlett Packard Color inkjet paper, Xerox Extra Bright white inkjet paper, Georgia-Pacific inkjet Paper Catalog Number 999013, Staples inkjet paper International Paper Great White MultiUse 20 Paper, Xerox Premium Multipurpose Paper, Hammermill Copy plus or ForeMP paper, and Hewlett Packard Multipurpose paper. The plain papers may include papers that have been treated with multivalent salts during or after manufacture of the paper.

Inks of the present invention can be printed as digital images having photographic quality if a suitable recording medium, such as glossy inkjet paper, is used. Photoglossy receivers may be further categorized as being a swellable media (having a non-porous polymer coating) or a microporous media, although hybrid designs are also well known. The microporous media are typically comprised of water-absorbing fine particles or powders mixed with a polymeric hydrophilic binder to form a microporous structured coating. The hydrophilic particles or powders are typically polycrystalline inorganic materials such as boehmite alumina, porous and non-porous silicas (for example Sylojet or Ludox particles), or amorphous inorganic materials such as aluminum silicates. Microporous photoglossy media are preferred due to their relatively quick drying capabilities and improved water-fastness and smudge resistance compared to swellable media. The design of both the plain paper and photoglossy media vary widely depending on materials and paper manufacturing processes and should not be construed to limit the scope of the present invention.

The following examples illustrate, but do not limit, the utility of the present invention.

### EXAMPLES

### Acrylic Polymers Used in the Ink Examples

Acrylic Polymer AC-1: A copolymer of benzylmethacrylate, stearylmethacrylate, and methacrylic acid in a monomer weight ratio of 37/30/33 having a weight average molecular weight of 9030 as determined by the Size Exclusion Chromatography. The polymer is neutralized with potassium hydroxide to have a degree of neutralization of about 85%.

Acrylic Polymer AC-2: A copolymer of benzylmethacrylate, stearylmethacrylate, and methacrylic acid in a monomer weight ratio of 45/30/25 having a weight average molecular weight of 8430 as determined by the Size Exclusion Chromatography. The polymer is neutralized with potassium hydroxide to have a degree of neutralization of about 85%.

Acrylic Polymer AC-3: A copolymer of benzylmethacrylate, stearylmethacrylate, and methacrylic acid in a monomer weight ratio of 45/35/20 having a weight average molecular weight of 7910 as determined by the Size Exclusion Chromatography. The polymer is neutralized with potassium hydroxide to have a degree of neutralization of about 85%.

Acrylic Polymer AC-4: A copolymer of benzylmethacrylate, stearylmethacrylate, carboxyethylacrylate, and methacrylic acid in a monomer weight ratio of 30/30/20/20 having a weight average molecular weight of 8190 as determined by the Size Exclusion Chromatography. The polymer is neutralized with potassium hydroxide to have a degree of neutralization of about 85%.

Acrylic Polymer AC-5: A copolymer of benzylmethacrylate and methacrylic acid in a monomer weight ratio of 67/33. The polymer is neutralized with potassium hydroxide to have a degree of neutralization of about 85%.

Acrylic Polymer AC-6: A copolymer of stearylmethacrylate and methacrylic acid in a monomer weight ratio of 67/33. The polymer is neutralized with potassium hydroxide to have a degree of neutralization of about 85%.

Acrylic Polymer AC-7: A copolymer of benzylmethacrylate, stearylmethacrylate and methacrylic acid in a monomer weight ratio of 43/35/22. The polymer is neutralized with potassium hydroxide to have a degree of neutralization of about 85%.

### Polyurethane Dispersions Used in the Ink Examples

Polyurethane dispersions shown in the ink examples below typically have particle sizes in the range from about 10 to about 40 nanometers in diameter. These sizes may change depending on the specific aqueous environment of the ink formulations. Unless otherwise stated, the polyurethane dispersions are prepared by carrying out the polymerization reaction in tetrahydrofuran (THF) using isophorone diisocyante, 2,2-bis(hydroxymethyl)propionic acid, and a polyol, neutralizing the resultant polymer with aqueous potassium hydroxide solution, diluting with additional deionized water if necessary, and removing THF by vacuum evaporation or stripping.

Polyurethane PU-1: A 76 acid number polyurethane having a weight average molecular weight of 26,100 made with isophorone diisocyanate and a combination of poly(hexamethylene carbonate) diol and 2,2-bis(hydroxymethyl)proprionic acid, where 100% of the acid groups are neutralized with potassium hydroxide.

Polyurethane PU-2: An 85 acid number polyurethane having a weight average molecular weight of 39,800 made with isophorone diisocyanate and a combination of 2000 MW polytetrahydrofuran polyol and 2,2-bis(hydroxymethyl)proprionic acid, where 95% of the acid groups are neutralized with potassium hydroxide.

Polyurethane PU-3: A 100 acid number polyurethane having a weight average molecular weight of 19,300 made with isophorone diisocyanate and a combination of 2000 MW polytetrahydrofuran polyol and 2,2-bis(hydroxymethyl)proprionic acid, where 95% of the acid groups are neutralized with potassium hydroxide.

Polyurethane PU-4: A 120 acid number polyurethane having a weight average molecular weight of 17,100 made with isophorone diisocyanate and a combination of 2000 MW polytetrahydrofuran polyol and 2,2-bis(hydroxymethyl)proprionic acid, where 95% of the acid groups are neutralized with potassium hydroxide.

Polyurethane PU-5: A 139 acid number polyurethane having a weight average molecular weight of 8,000 made with isophorone diisocyanate and a combination of poly(hexamethylene carbonate) diol and 2,2-bis(hydroxymethyl)proprionic acid where 95% of the acid groups are neutralized with potassium hydroxide.

### Preparation of Pigment Dispersions

A series of aqueous pigment dispersions were prepared using a high speed mill equipped with polymeric milling media having a diameter of 50 microns until the median size of the pigments were below 100 nm. Pigment:dispersant weight ratios were in the range of approximately 2:1 to 4:1.

M-1: A dispersion of magenta pigment Cromophtal Jet Magenta PR2BC® (Ciba Specialty Chemicals) with the potassium salt of oleylmethyltaurate.

M-2: A dispersion of magenta pigment Ciba Cromophtal Jet Magenta PR2BC with the acrylic copolymer AC-1.

M-3: A dispersion of magenta pigment Ciba Cromophtal Jet Magenta PR2BC with the acrylic copolymer AC-2.

M-4: A dispersion of magenta pigment Ciba Cromophtal Jet Magenta PR2BC with the acrylic copolymer AC-3.

M-5: A dispersion of magenta pigment Ciba Cromophtal Jet Magenta PR2BC with the acrylic copolymer AC-4.

M-6: A dispersion of magenta pigment CI Pigment Red 122 with the acrylic copolymer AC-1.

M-7: A dispersion of magenta pigment CI Pigment Red 122 with the acrylic copolymer AC-5.

M-8: A dispersion of magenta pigment CI Pigment Red 122 with the acrylic copolymer AC-6.

C-1: A dispersion of cyan pigment copper phthalocyanine PB15:3 with the acrylic copolymer AC-1.

C-2: A dispersion of cyan pigment copper phthalocyanine PB15:3 with the acrylic copolymer AC-7.

K-1: A dispersion of carbon black Cabot® Black Pearls 880 with acrylic copolymer AC-1.

K-2: A dispersion of carbon black Cabot® Black Pearls 880 with acrylic copolymer AC-7.

### Preparation of Inks

A series of magenta inks were prepared from each pigment dispersion by dilution using high purity water such that the final concentrations were 3.0% pigment, 1.2% polyurethane (PU), 0.02% Kordek MLX® (Rohm and Haas) biocide, and 0.3% Strodex PK-90® (Dexter Chemical). Additional ink ingredients are provided in Table 1. The inks were pH adjusted to between 8.0 and 8.6 using 0.1N potassium hydroxide and filtered through a 1.0 micron disk filter.

TABLE 1
Magenta Ink Compositions

| | Pigment | | Glyc | EG | DEG | PEG | | TEG | HD | PEG-MBE |
|---|---|---|---|---|---|---|---|---|---|---|
| Ink | Dispersion | PU | Wt % | Wt % | Wt % | Wt % | 2-P Wt % | Wt % | Wt % | Wt % |
| 1 | M-1 | −1 | 8 | | 5 | 3 | | | | |
| 2 | M-1 | −1 | 8 | | 5 | 3 | | | | 5 |
| 3 | M-2 | −1 | 8 | | 5 | 3 | | | | |
| 4 | M-2 | −1 | 8 | | 5 | 3 | | | | 5 |
| 5 | M-3 | −1 | 8 | | 5 | 3 | | | | |
| 6 | M-3 | −1 | 8 | | 5 | 3 | | | | 5 |
| 7 | M-4 | −1 | 8 | | 5 | 3 | | | | |
| 8 | M-4 | −1 | 8 | | 5 | 3 | | | | 5 |
| 9 | M-5 | −2 | 8 | | | | 5 | | 3 | |
| 10 | M-5 | −2 | 12 | | | | 5 | | 3 | |
| 11 | M-5 | −2 | 12 | | | | 5 | | | 5 |
| 12 | M-5 | −3 | 8 | | | | 5 | | | |
| 13 | M-5 | −3 | 8 | | | | 5 | | 3 | |
| 14 | M-5 | −3 | 12 | | | | 5 | | 3 | |
| 15 | M-5 | −3 | 12 | | | | 5 | | | 5 |
| 16 | M-5 | −4 | 8 | | | | 5 | | | |
| 17 | M-5 | −4 | 8 | | | | 5 | | 3 | |
| 18 | M-5 | −4 | 12 | | | | 5 | | 3 | |
| 19 | M-5 | −4 | 12 | | | | 5 | | | 5 |
| 20 | M-5 | −3 | 8 | | | | 5 | | 3 | |
| 21 | M-5 | −3 | 8 | | | | | 5 | 3 | |
| 22 | M-5 | −3 | 8 | | | | 5 | 5 | 3 | |
| 23 | M-2 | −3 | 8 | | | | 5 | | 3 | |
| 24 | M-2 | −3 | 8 | | | | | 5 | 3 | |
| 25 | M-2 | −3 | 8 | | | | 5 | 5 | 3 | |
| 26 | M-3 | −3 | 8 | | | | 5 | | 3 | |
| 27 | M-3 | −3 | 8 | | | | | 5 | 3 | |
| 28 | M-3 | −3 | 8 | | | | 5 | 5 | 3 | |
| 29 | M-4 | −3 | 8 | | | | 5 | | 3 | |
| 30 | M-4 | −3 | 8 | | | | | 5 | 3 | |
| 31 | M-4 | −3 | 8 | | | | 5 | 5 | 3 | |
| 32 | M-6 | | | 5 | | 10 | | | | |
| 33 | M-6 | −5 | | 5 | | 10 | | | | |
| 34 | M-6 | | 6 | | | 5 | 2 | | | |
| 35 | M-6 | −5 | 6 | | | 5 | 2 | | | |
| 36 | M-6 | | 10 | 5 | | | | | | |
| 37 | M-6 | −5 | 10 | 5 | | | | | | |
| 38 | M-7 | | | 5 | | 10 | | | | |
| 39 | M-7 | −5 | | 5 | | 10 | | | | |
| 40 | M-7 | | 6 | | | 5 | 2 | | | |
| 41 | M-7 | −5 | 6 | | | 5 | 2 | | | |
| 42 | M-7 | | 10 | 5 | | | | | | |
| 43 | M-7 | −5 | 10 | 5 | | | | | | |

The humectants and co-solvents in Table 1 are defined as:
Glyc is glycerol
EG is ethylene glycol
DEG is diethylene glycol
PEG is 400 molecular weight polyethylene glycol
2-P is 2-pyrrolidinone
TEG is triethylene glycol
HD is 1,2-hexane diol
PEG-MBE is polyethylene glycol monobutyl ether

A cyan ink was prepared in an approximately 150 ml high density polyethylene bottle with magnetic stirring. The following components were added in order: 74.84 g of high purity water; 0.26 g of a 9.5 wt % solution of the biocide Kordek MLX, 5.0 g of glycerol; 2.5 g of 2-pyrrolidinone; 2.5 g of 1-(2-hydroxyethyl)-2-pyrrolidinone (HEP); 2.5g of 1,5-pentanediol; 2.5 g of triethylene glycol (TEG); 3.75 g 1,2-hexanediol; 0.13 g of the surfactant Strodex PK90; and 26.96 g of the cyan pigment dispersion C-1 containing 10.2 wt % pigment. 0.06 g of 1N potassium hydroxide was added to adjust the pH. The resulting 125 g of ink were stirred for at least an hour and filtered with a 1.0 um disk filter. This ink is denoted as ink 44. Additional cyan ink formulas are provided in Table 2. When present, the polyurethane binder level is 1.2% by weight of the ink.

A carbon black pigment ink was prepared according to the formulation used for ink 44 except 29.76 grams of carbon black pigment dispersion K-1 was used in place of cyan dispersion C-1 and the water was adjusted to yield 125 grams of ink. This ink is denoted as ink 50. Additional carbon black pigment ink formulas are provided in Table 2. When present, the polyurethane binder level is 1.2% by weight of the ink.

TABLE 2
Cyan and Carbon Black Ink Compositions

| | Pigment | | | | | | | | |
|---|---|---|---|---|---|---|---|---|---|
| | Disper- | Acrylic | | Glyc | 2-P | HEP | PD | TEG | HD |
| INK | sion | Polymer | PU | wt % | wt % | wt % | wt % | wt % | wt % |
| 44 | C-1 | AC-1 | | 4 | 2 | 2 | 2 | 2 | 3 |
| 45 | C-1 | AC-1 | −3 | 4 | 2 | 2 | 2 | 2 | 3 |
| 46 | C-1 | AC-1 | −5 | 4 | 2 | 2 | 2 | 2 | 3 |
| 47 | C-2 | AC-7 | | 4 | 2 | 2 | 2 | 2 | 3 |
| 48 | C-2 | AC-7 | −3 | 4 | 2 | 2 | 2 | 2 | 3 |
| 49 | C-2 | AC-7 | −5 | 4 | 2 | 2 | 2 | 2 | 3 |
| 50 | K-1 | AC-1 | | 4 | 2 | 2 | 2 | 2 | 3 |
| 51 | K-1 | AC-1 | −3 | 4 | 2 | 2 | 2 | 2 | 3 |
| 52 | K-1 | AC-1 | −5 | 4 | 2 | 2 | 2 | 2 | 3 |
| 53 | K-2 | AC-7 | | 4 | 2 | 2 | 2 | 2 | 3 |
| 54 | K-2 | AC-7 | −3 | 4 | 2 | 2 | 2 | 2 | 3 |
| 55 | K-2 | AC-7 | −5 | 4 | 2 | 2 | 2 | 2 | 3 |

The humectants and co-solvents in Table 2 are defined as:
Glyc is glycerol
2-P is 2-pyrrolidinone
HEP is 1-(2-hydroxyethyl)-2-pyrrolidinone
TEG is triethylene glycol
PD is 1,5-pentane diol

### Ink Performance Results

Each of inks 1 through 31 and 44-55 was loaded directly into a thermal print head with 3 picoliter nozzles. At voltages of 6 and 12% above the threshold voltage for the ink to begin firing, the transit time for each drop to travel 0.3 mm from the nozzle plate was measured for 250 drops at each of a set of varying firing frequencies from 0 to 25,000 Hz. The average velocity and the root mean square variation of the velocity were calculated for 10 different nozzles fired at identical conditions. Jetting results are provided in Table 3.

The initial particle size of each of inks 1-31 was measured using a NANOTRAC® Ultrafine Particle Analyzer from Microtrac. A sample of ink was incubated in a sealed polyethylene bottle at a temperature of 50 degrees Celsius for six weeks and the particle size was again measured. The percent change in particle size before and after incubation are reported in Table 3 and is a measure of the ability of the dispersant to stabilize the fine particle pigments in an ink. Ink viscosities were also measured for these inks using a capillary viscometer at a temperature of 25 degrees C. and are reported in centapoise in Table 3.

TABLE 3
Ink Performance Data

| | | Percent | Jetting | Jetting velocity |
|---|---|---|---|---|
| Ink | Ink | change in | velocity m/s | variation % at |
| Type | viscosity | particle size | at 12 kHz | 12 kHz |
| 1 comparison | 1.92 | −3 | 9.35 | 3.5 |
| 2 comparison | 2.42 | 1283 | 3.61 | 10.5 |
| 3 invention | 2.06 | 4 | 16.7 | 1.1 |
| 4 invention | 2.53 | 1 | 14 | 1.7 |
| 5 invention | 2.03 | −3 | 15.8 | 1.2 |
| 6 invention | 2.54 | 110 | 13.5 | 2.0 |
| 7 invention | 3.04 | −41 | 15.5 | 1.9 |
| 8 invention | 3.53 | 1342 | 10.4 | 3.2 |
| 9 invention | 2.34 | −5 | 19.0 | 0.9 |
| 10 invention | 2.69 | −4 | 18.2 | 0.6 |
| 11 invention | 2.95 | −1 | 16.8 | 1.4 |
| 12 invention | 1.94 | −15 | 19.5 | 0.7 |
| 13 invention | 2.20 | −4 | 18.1 | 1.0 |
| 14 invention | 2.51 | −2 | 17.3 | 0.8 |
| 15 invention | 2.71 | 4 | 16.4 | 1.4 |
| 16 invention | 1.98 | −16 | 19.9 | 0.7 |
| 17 invention | 2.23 | −4 | 18.4 | 1.1 |
| 18 invention | 2.60 | 0 | 18.1 | 0.7 |
| 19 invention | 2.82 | 3 | 17.3 | 1.4 |
| 20 invention | 2.16 | 1 | 19.2 | 1.0 |
| 21 invention | 2.24 | −3 | 18.6 | 1.1 |
| 22 invention | 2.63 | 1 | 18.8 | 0.6 |
| 23 invention | 2.07 | 7 | 18.8 | 1.3 |
| 24 invention | 2.12 | 5 | 18.8 | 1.2 |
| 25 invention | 2.76 | 9 | 17.5 | 0.8 |
| 26 invention | 2.13 | −1 | 18.6 | 1.5 |
| 27 invention | 2.16 | 1 | 17.8 | 1.2 |
| 28 invention | 2.59 | 8 | 17.3 | 1.3 |
| 29 invention | 3.31 | −42 | 17.9 | 1.3 |
| 30 invention | 3.33 | −28 | 17.6 | 1.1 |
| 31 invention | 3.90 | −34 | 16.9 | 2.0 |
| 44 comparison | | | 12.1 | 1.9 |
| 45 invention | | | 16.7 | 1.9 |
| 46 invention | | | 13.6 | 1.3 |
| 47 comparison | | | 10.9 | 6.1 |
| 48 invention | | | 17.4 | 2.1 |
| 49 invention | | | 11.4 | 1.7 |
| 50 comparison | | | 16.7 | 0.8 |
| 51 invention | | | 17.4 | 0.9 |
| 52 invention | | | 14.9 | 1.7 |
| 53 comparison | | | 10.8 | 3.3 |
| 54 invention | | | 17.9 | 1.9 |
| 55 invention | | | 13.3 | 0.9 |

Table 3 illustrates the advantageous firing performance from a thermal inkjet printhead of inventive inks formulated with the inventive combination of polymeric dispersant and water-dispersible polyurethane binder. Furthermore, Table 3 shows that inks formulated with a polymeric dispersant, but without a polyurethane, jet poorly with low drop velocity and/or high velocity variation such as inks I-44, I-47, and I-53. The addition of polyurethane to inks comprising pigments dispersed with the polymeric dispersants improves both the velocity of the ink droplet and the velocity variation. In the case of an ink such as I-50 that shows good jetting without polyurethane, the appropriately chosen polyurethane can still impart further velocity improvement as shown in ink I-51 and will improve the durability of the printed ink.

### Plain Paper Printing Performance

Each of inks 32 through 43 was loaded into empty ink cartridges; the cartridges were then loaded into a Canon i960 Photo Printer (Canon U.S.A, Inc.) thermal inkjet printer. A stepped target was printed onto Xerox EXTRA BRIGHT® Inkjet Paper (Xerox Corporation) such that uniform patches of ink were laid down in increments from 10 to 100%. The drivers for the CMYK channels were set up to lay down the same amount of ink from each channel. Status A RGB and Visible (neutral) patch densities were measured using a Spectralino instrument. The densities reported in Table 4 below are the maximum densities that were obtained (i.e., at 100% ink laydown).

TABLE 4
Densities of Polymerically Dispersed Pigments
and Polyurethane inks on plain paper.

| | Polymer | | |
|---|---|---|---|
| Ink | Dispersant | PU | Density |
| 32 comparison | AC-1 | none | 1.17 |
| 33 invention | AC-1 | −5 | 1.16 |
| 34 comparison | AC-1 | none | 1.15 |
| 35 invention | AC-1 | −5 | 1.12 |
| 36 comparison | AC-1 | none | 1.14 |
| 37 invention | AC-1 | −5 | 0.90 |
| 38 comparison | AC-5 | none | 1.17 |
| 39 comparison | AC-5 | −5 | 1.13 |
| 40 comparison | AC-5 | none | 1.15 |
| 41 comparison | AC-5 | −5 | 0.90 |
| 42 comparison | AC-5 | none | 0.95 |
| 43 comparison | AC-5 | −5 | 0.83 |

Comparisons of Ink 33 to Ink 39, Ink 35 to Ink 41, and ink 37 to Ink 43 in Table 4 shows that inks having the inventive combination of a pigment dispersed with the claimed polymeric dispersants and a water-dispersible polyurethane defined herein result in advantageous densities when printed to a plain paper.

The invention has been described with reference to a preferred embodiment. However, it will be appreciated that variations and modifications can be affected by a person of ordinary skill in the art without departing from the scope of the invention.

1. An inkjet ink composition comprising:
(a) water;
(b) a pigment dispersion comprising a pigment and a polymeric dispersant wherein the polymeric dispersant is a copolymer comprising at least a hydrophobic methacrylate or acrylate monomer containing an aliphatic chain having greater than or equal to 12 carbons, and a hydrophilic methacrylic or acrylic acid monomer, wherein the copolymer comprises at least 10% by weight of the hydrophobic methacrylate or acrylate monomer and at least 5% by weight of the hydrophilic methacrylic or acrylic acid monomer, and wherein the copolymer comprises, in total, 20 to 95 weight % of hydrophobic monomer; and
(c) at least one water-dispersible polyurethane.

2. The ink composition of claim 1, further comprising at least one humectant.

3. The ink composition of claim 1, wherein the at least one water-dispersible polyurethane has a weight average molecular weight of at least 8,000.

4. The ink composition of claim 1, wherein the at least one water-dispersible polyurethane has a weight average molecular weight of between 5,000 and 50,000.

5. The ink composition of claim 1, wherein the polymeric dispersant has a weight average molecular weight of less than 15,000.

6. The ink composition of claim 1, wherein the hydrophobic methacrylate or acrylate monomer is stearyl or lauryl methacrylate, or stearyl or lauryl acrylate.

7. The ink composition of claim 6 wherein the copolymer further comprises benzyl methacrylate or benzyl acrylate.

8. The ink composition of claim 1 wherein the copolymer further comprises benzyl methacrylate or benzyl acrylate.

9. The ink composition of claim 1, wherein the copolymer comprises at least 15% by weight of the hydrophilic methacrylic or acrylic acid monomer.

10. The ink composition of claim 1, wherein the copolymer comprises at least 20% by weight of the hydrophilic methacrylic or acrylic acid monomer.

11. The ink composition of claim 1, wherein the copolymer comprises at least 20% by weight of the hydrophobic methacrylate or acrylate monomer.

12. The ink composition of claim 1, wherein pigment particles have a median particle diameter of less than 100 nm.

13. The ink composition of claim 1, wherein the at least one water-dispersible polyurethane has an acid number between 50 and 150.

14. The ink composition of claim 1, wherein the viscosity of the ink is less than 4 centapoise at 25 degrees Celsius.

15. The ink composition of claim 1, wherein the polymeric dispersant is neutralized with a monovalent inorganic base selected from: potassium hydroxide, sodium hydroxide, lithium hydroxide, or rubidium hydroxide.

16. The ink composition of claim 1, wherein the ink composition can be jetted from a thermal inkjet device at frequencies of at least 12 kHz with a near nozzle velocity of at least 10 meters/second.

17. The ink composition of claim 16, wherein the ink composition has a velocity variation of less than 2% for at least 5×10⁷ firing events.

18. An inkjet ink set comprising two or more ink compositions, wherein at least one of the two or more ink compositions comprises an ink according to claim 1.

19. An ink set according to claim 18, wherein at least two of the two or more ink compositions comprise inks according to claim 1.

20. A process of forming an image comprising jetting the inkjet ink of claim 1 onto a media
